(19) United States
(12) Patent Application Publication
(10) Pub. No.: US 2011/0255715 A1
(43) Pub. Date: Oct. 20, 2011

(54) MULTIFUNCTIONAL MICRO-SPEAKER

(75) Inventors: Sung-Hwan Doh, Gyeonggi-do (KR); Han-Ryang Lee, Gyeonggi-do (KR); Sang-Ho Lee, Incheon (KR)

(73) Assignee: BSE CO., LTD., Incheon (KR)

(21) Appl. No.: 13/142,152

(22) PCT Filed: Jul. 23, 2009
(86) PCT No.: PCT/KR2009/004107

§ 371 Date: Jun. 24, 2011

(30) Foreign Application Priority Data
May 8, 2009 (KR) 10-2009-0040387

(51) Int. Cl. H04R 9/06

(52) U.S. Cl. 381/162; 381/398

(57) ABSTRACT

An integrated multifunctional micro speaker including a speaker frame having an upper portion (an outer portion) that is configured by a moving voice coil type speaker and a lower portion (an inner portion) that is configured by a moving magnet and weight type vibrator supported by a suspension, thereby reproducing a sound and a vibration. The multifunctional micro speaker includes a cylindrical speaker frame; a yoke having an end fixed to the cylindrical speaker frame; a speaker magnet fixed onto the yoke; a speaker plate fixed onto the speaker magnet; a diaphragm having an outer circumferential surface supported against the cylindrical speaker frame; a voice coil that is attached to the diaphragm so as to be disposed in a space formed between the speaker plate and the yoke; a suspension fixed to a lower portion of the speaker frame; a cylindrical weight attached to a central portion of the suspension; a lower plate attached onto the cylindrical weight and having the same shape as the cylindrical weight; a vibrator magnet attached onto the lower plate and having the same shape as the lower plate; an upper plate attached onto the vibrator magnet and having the same shape as the vibrator magnet; and a vibrator coil attached to the yoke.

### TECHNICAL FIELD

One or more aspects of the present invention relate to multifunctional micro speakers having both vibration and voice functions, and more particularly, to a multifunctional micro speaker including a speaker frame having an outer portion that is configured by a moving voice coil type speaker and an inner portion that is configured by a moving magnet and weight type vibrator supported by a suspension, thereby reproducing a sound and a vibration.

### BACKGROUND ART

A speaker is an audio device that converts an electrical signal flowing through a voice coil into kinetic energy in a magnetic field circuit so as to generate a compression wave in order to generate a sound wave. Speakers have been widely used in cellular phones or various portable electronic products.

Portable electronic products such as cellular phones include a vibration module for indicating an incoming call and for performing a bone-conducting function or the like. In order to miniaturize a product and reduce manufacturing costs, a multifunctional micro speaker that also has a vibrating function has been developed and widely used.

As shown in FIG. 1, a conventional multifunctional speaker 10 includes a diaphragm 11 to which a voice coil 12 is attached, a frame 13 for supporting the diaphragm 11, and a vibrator including a plate 15, a magnet 14, and a yoke 16 that are supported against the frame 13 by a single suspension 17. The conventional multifunctional speaker 10 vibrates the diaphragm 11, thereby generating a sound when a voice signal is input to the voice coil 12. In addition, when a vibration signal is input to the diaphragm 11, the vibration module moves up and down.

However, since the conventional multifunctional speaker 10 uses a single magnetic circuit as a vibrator, when the magnetic circuit which is the vibrator vibrates, an abnormal sound is generated due to phase inversion with the diaphragm 11. If a separate magnetic circuit is used so that a diaphragm is separated from the magnetic circuit in order to remove the abnormal sound, sound leakage occurs due to a space formed between the magnetic circuit and the diaphragm, thereby reducing a sound pressure level and a reproduction band. In addition, if a separate vibration coil is used, an unstable vibration is generated due to eccentric deviation of suspension-vibrator-coil. If a weight for increasing the weight of a component is off-center with respect to the vibrator, an unstable vibration is generated due to a change of the center of gravity.

### DISCLOSURE OF THE INVENTION

### Technical Problem

One or more aspects of the present invention provide an integrated multifunctional micro speaker including a speaker frame having an upper portion (an outer portion) that is configured by a moving voice coil type speaker and a lower portion (an inner portion) that is configured by a moving magnet and weight type vibrator supported by a suspension, thereby reproducing a sound and a vibration.

### Technical Solution

According to an aspect of the present invention, there is provided a multifunctional micro speaker including a speaker frame; a speaker portion of a moving voice coil type, which is formed in an upper-outer portion of the speaker frame; and a vibrator portion of a moving magnet type, which is supported by a suspension and is formed in a lower-inner portion of the speaker frame, wherein the speaker portion and the vibrator portion vibrate separately so that vibration displacements of the speaker portion and the vibrator portion do not interfere with each other.

The speaker portion may include a yoke having an end fixed to the speaker frame; a speaker magnet fixed onto the yoke; a speaker plate fixed onto the speaker magnet; a diaphragm having an outer circumferential surface supported against the speaker frame; and a voice coil that is attached to the diaphragm so as to be disposed in a space formed between the speaker plate and the yoke, wherein, when a current flows along the voice coil, the diaphragm vibrates and generates a sound. In addition, the vibrator portion may include a suspension fixed to a lower portion of the speaker frame; a lower plate attached onto a weight and having the same shape as the weight; a vibrator magnet attached onto the lower plate and having the same shape as the lower plate; an upper plate attached onto the vibrator magnet and having the same shape as the vibrator magnet; and a vibrator coil attached to the yoke, wherein, when a current flows through the vibrator coil, a vibrator supported by the suspension vibrates.

### Advantageous Effects

In a multifunctional micro speaker according to one or more embodiments of the present invention, an upper portion (an outer portion) of a speaker frame is configured by a moving voice coil type speaker, and a lower portion (an inner portion) of the speaker frame is configured by a moving magnet and weight type vibrator supported by a suspension. Thus, a space of multifunctional micro speaker may be divided so that vibration displacements may not interfere with each other and a diaphragm and a vibrator may separately vibrate without any sound leakage. When the vibrator and diaphragm vibrate simultaneously, an abnormal sound generated due to a phase inversion may be removed, and a reproduction distortion generated due to an eccentricity deviation between components may be minimized.

In addition, in the multifunctional micro speaker according to one or more embodiments of the present invention, a weight for increasing the weight of the multifunctional micro speaker is attached to a central portion of a suspension, thereby preventing a change of the center of gravity of the multifunctional micro speaker. In addition, a protrusion is formed on a yoke, thereby minimizing a change in a magnetic force line due to a vibration displacement.

### BRIEF DESCRIPTION OF THE DRAWINGS

FIG. 1 is a schematic cross-sectional view of a conventional multifunctional speaker;

FIG. 2 is a perspective view of a multifunctional micro speaker in an assembled state, according to an embodiment of the present invention;

FIG. 3 is a perspective cross sectional view of the multifunctional micro speaker of FIG. 2;

FIG. 4 is a cross-sectional view of a multifunctional micro speaker according to another embodiment of the present invention;

FIG. 5 is a cross-sectional view of a magnified portion of the multifunctional micro speaker of FIG. 4;

FIG. 6 is a cross-sectional view of a magnified portion of a multifunctional micro speaker according to another embodiment of the present invention.

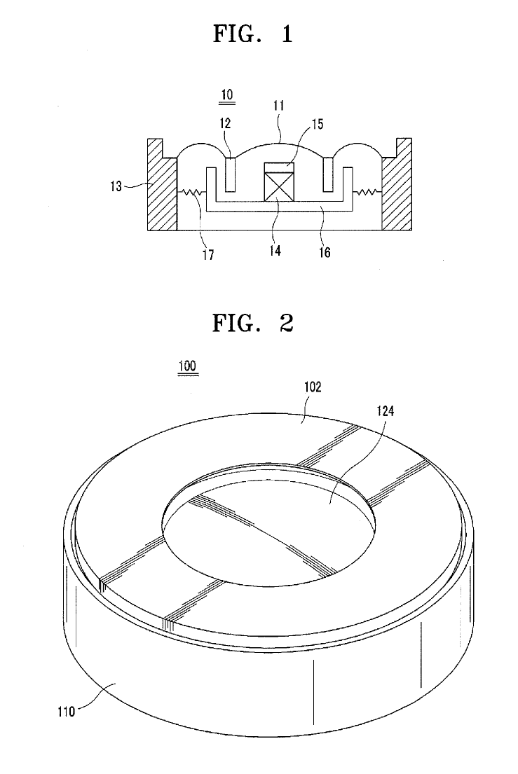

### BEST MODE FOR CARRYING OUT THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

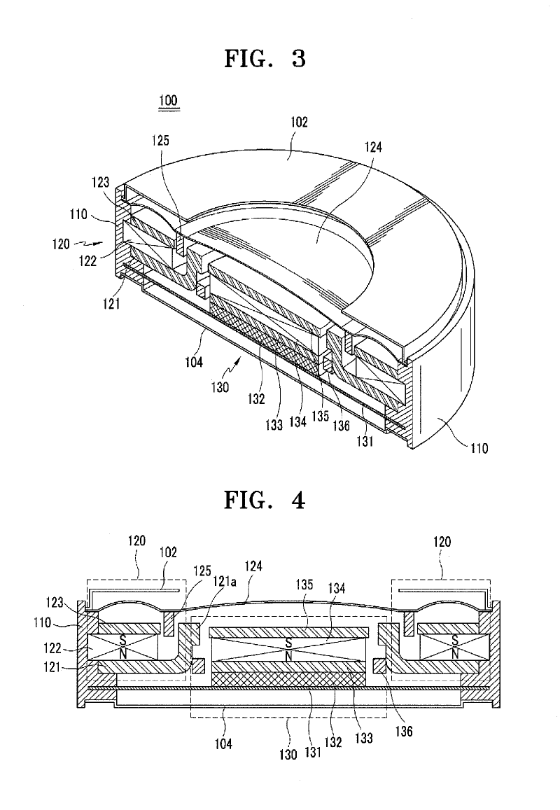

FIG. 2 is a perspective view of a multifunctional micro speaker 100 in an assembled state, according to an embodiment of the present invention. FIG. 3 is a perspective cross sectional view of the multifunctional micro speaker 100 of FIG. 2.

Referring to FIGS. 2 and 3, the multifunctional micro speaker 100 includes a cylindrical speaker frame 110, a front cover 102, a rear cover 104, a yoke 121 fixed to the cylindrical speaker frame 110, a speaker magnet 122 and a speaker plate 123, which are fixed to the cylindrical speaker frame 110, a diaphragm 124, a voice coil 125 that is attached to the diaphragm 124 so as to be disposed between the yoke 121, and the speaker magnet 122 and the speaker plate 123, a suspension 131 fixed to a lower portion of the cylindrical speaker frame 110, a vibration coil 136 fixed to an outer portion of the yoke 121, a weight 132 attached to a central portion of the suspension 131, a lower plate 133 attached onto the weight 132, a vibrator magnet 134, and an upper plate 135. An internal space formed by the cylindrical speaker frame 110 is divided into upper and lower portions, and inner and outer portions. An upper-outer portion is operated by a speaker portion 120, and a lower-inner portion is operated by a vibrator portion 130. Thus, the upper-outer portion and the lower-inner portion are separately operated so that vibration displacements of the upper-outer portion and the lower-inner portion do not interfere with each other.

As shown in FIGS. 2 and 3, the multifunctional micro speaker 100 includes the speaker portion 120 and the vibrator portion 130. In this case, the speaker portion 120 is of a moving voice type and is configured by the upper-outer portion of the space formed by the cylindrical speaker frame 110. The vibrator portion 130 is of a moving magnet and weight type, is supported by the suspension 131, and is configured by the lower and inner portion of the space formed by the cylindrical speaker frame 110.

The speaker portion 120 includes the yoke having an end fixed to the cylindrical speaker frame 110, the speaker magnet 122 fixed onto the yoke 121, the speaker plate 123 attached onto the speaker magnet 122, the diaphragm 124 having an outer circumferential surface supported against the cylindrical speaker frame 110, and a voice coil 125 that is attached to the diaphragm 124 so as to be disposed in a gap formed between the speaker plate 123 and the yoke 121. When a current flows through the voice coil 125, the diaphragm 124 may vibrate and a sound is generated. In this case, the yoke 121 includes a protrusion 121a that protrudes from an end portion thereof, thereby minimizing a change in the magnetic line of force due to a vibration displacement.

The vibrator portion 130 includes the suspension 131 fixed to a lower portion of the cylindrical speaker frame 110, the weight 132 having a disk shape and attached to the central portion of the suspension 131, the lower plate 133 attached onto the weight 132 and having the same shape as the weight 132, the vibrator magnet 134 attached onto the lower plate 133 and having the same shape as the lower plate 133, the upper plate 135 attached onto the vibrator magnet 134 and having the same shape as the vibrator magnet 134, and a vibrator coil 136 attached to the yoke 121. When a current flows through the vibrator coil 136, a vibrator supported by the suspension 131 may vibrate.

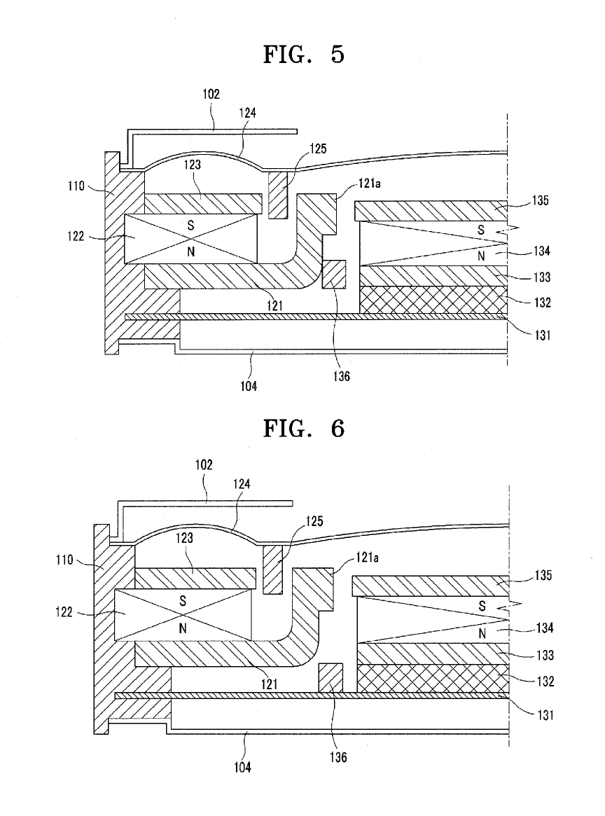

FIG. 4 is a cross-sectional view of a multifunctional micro speaker 100 according to another embodiment of the present invention. FIG. 5 is a cross-sectional view of a magnified portion of the multifunctional micro speaker 100 of FIG. 4.

A structure of the multifunctional micro speaker 100 according to the present embodiment will be described in detail. Referring to FIGS. 4 and 5, a vibrator magnet assembly supported by the suspension 131 and the weight 132 are fixed to a central portion of the cylindrical speaker frame 110. A speaker magnet assembly is fixed to an inner circumferential surface of the cylindrical speaker frame 110 above the yoke 121 supported against the cylindrical speaker frame 110. In addition, the voice coil 125 attached to the diaphragm 124 is disposed between the yoke 121 and the speaker plate 123. When a current flows through the voice coil 125, a magnetic field generated by the speaker magnet 122 and an electric field generated by the voice coil 125 interact with each other so that the diaphragm 124 may vibrate.

Since the vibrator coil 136 is attached to the outer portion of the yoke 121, when a current flows through the vibrator coil 136, a magnetic field generated by the vibrator magnet 134 and an electronic field generated by the vibrator coil 136 interact with each other so that the weight 132, the vibrator magnet 134, and the upper and lower plates 133 and 135, which are supported by the suspension 131, may vibrate.

Thus, the multifunctional micro speaker 100 may separately or simultaneously reproduce a sound and a vibration. When the vibrator portion 130 and the diaphragm 124 vibrate simultaneously, an abnormal sound generated due to a phase inversion is removed, and a reproduction distortion generated due to an eccentricity deviation may be minimized.

In addition, the speaker portion 120 and the vibrator portion 130 are configured to be of a dynamic type having relatively high efficiency. Since the speaker portion 120 and the vibrator portion 130 vibrate independently and separately, vibration displacements of the speaker portion 120 and the vibrator portion 130 may not interfere with each other. In addition, the speaker portion 120 and the vibrator portion 130 are divided according to upper and lower portions, and inner and outer portions of the cylindrical speaker frame 110. Since the speaker portion 120 and the vibrator portion 130 vibrate separately, phases may not interfere with each other. In addition, the vibration coil 136 is attached to the yoke 121 fixed to the cylindrical speaker frame 110, thereby reducing an eccentricity deviation between the suspension 131 and the vibrator portion 130.

The multifunctional micro speaker 100 includes the weight 132 that is added to the central portion of the suspension 131 for increasing the weight of a component, thereby preventing a change of the center of gravity of the multifunctional micro speaker 100.

In the multifunctional micro speaker 100, the yoke 121 for inducting magnetic field lines is shared by the speaker portion 120 and the vibrator portion 130. In order to minimize a change in magnetic file lines, a height of the protrusion 121a may be increased and a lower diameter of the protrusion 121a may be adjusted.

FIG. 6 is a cross-sectional view of a magnified portion of a multifunctional micro speaker 100 according to another embodiment of the present invention.

Referring to FIG. 6, the multifunctional micro speaker 100 according to the present embodiment includes the suspension 131 fixed to a lower portion of the cylindrical speaker frame 110, the weight 132 having a disk shape and being attached to a central portion of the suspension 131, the lower plate 133 attached onto the weight 132 and having the same shape as the weight 132, the vibrator magnet 134 attached onto the lower plate 133 and having the same shape as the lower plate 133, the upper plate 135 attached onto the vibrator magnet 134 and having the same shape as the vibrator magnet 134, and the vibrator coil 136 attached to an upper portion of the suspension 131.

Referring to FIG. 6, in the multifunctional micro speaker 100, the vibrator coil 136 is fixed to an upper portion of the suspension 131 instead of to the yoke 121 so as to remove an excitation force and displacement interfere occurring due to simultaneous vibrations, thereby increasing a vibration force and a vibration displacement. In addition, the weight 132 for increasing a weight of a component is fixed to the central portion of the suspension 13 so as to prevent a change of the center of gravity of the multifunctional micro speaker 100, thereby attaining a stable vibration. Since the multifunctional micro speaker 100 of FIG. 6 is the same as in the above-described embodiments, except for the vibrator coil 136, the detailed description of the remaining components will be omitted.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A multifunctional micro speaker comprising:
a speaker frame;
a speaker portion of a moving voice coil type, which is formed in an upper-outer portion of the speaker frame; and
a vibrator portion of a moving magnet type, which is supported by a suspension and is formed in a lower-inner portion of the speaker frame,
wherein the speaker portion and the vibrator portion vibrate separately so that to vibration displacements of the speaker portion and the vibrator portion do not interfere with each other.

2. The multifunctional micro speaker of claim 1, wherein the speaker portion comprises:
a yoke having an end fixed to the speaker frame;
a speaker magnet fixed onto the yoke;
a speaker plate fixed onto the speaker magnet;
a diaphragm having an outer circumferential surface supported against the speaker frame; and
a voice coil that is attached to the diaphragm so as to be disposed in a space formed between the speaker plate and the yoke,
wherein, when a current flows along the voice coil, the diaphragm vibrates and generates a sound.

3. The multifunctional micro speaker of claim 2, wherein the yoke comprises a protrusion protruding from an end of the yoke so as to minimize a change in magnetic force lines due to a vibration displacement.

4. The multifunctional micro speaker of claim 2, wherein the vibrator portion comprises:
a suspension fixed to a lower portion of the speaker frame;
a lower plate attached onto a weight and having the same shape as the weight;
a vibrator magnet attached onto the lower plate and having the same shape as the lower plate;
an upper plate attached onto the vibrator magnet and having the same shape as the vibrator magnet; and
a vibrator coil attached to the yoke,
wherein, when a current flows through the vibrator coil, a vibrator supported by the suspension vibrates.

5. The multifunctional micro speaker of claim 2, wherein the vibrator portion comprises:
a suspension fixed to a lower portion of the speaker frame;
a lower plate attached onto a weight and having the same shape as the weight;
a vibrator magnet attached onto the lower plate and having the same shape as the lower plate;
an upper plate attached onto the vibrator magnet and having the same shape as the vibrator magnet; and
a vibrator coil attached to the suspension,
wherein, when a current flows through the vibrator coil, a vibrator supported by the suspension vibrates.

6. The multifunctional micro speaker of claim 4 or 5, wherein the vibrator portion further comprises a cylindrical weight that is attached to a central portion of the suspension.

7. A multifunctional micro speaker comprising:
a cylindrical speaker frame;
a yoke having an end fixed to the cylindrical speaker frame;
a speaker magnet fixed onto the yoke;
a speaker plate fixed onto the speaker magnet;
a diaphragm having an outer circumferential surface supported against the cylindrical speaker frame;
a voice coil that is attached to the diaphragm so as to be disposed in a space formed between the speaker plate and the yoke;
a suspension fixed to a lower portion of the speaker frame;
a cylindrical weight attached to a central portion of the suspension;
a lower plate attached onto the cylindrical weight and having the same shape as the cylindrical weight;
a vibrator magnet attached onto the lower plate and having the same shape as the lower plate;
an upper plate attached onto the vibrator magnet and having the same shape as the vibrator magnet; and
a vibrator coil attached to the yoke.
